(19) United States
(12) Patent Application Publication
(10) Pub. No.: US 2010/0046832 A1
(43) Pub. Date: Feb. 25, 2010

(54) SYSTEM AND METHOD FOR BACKLIT IMAGE ADJUSTMENT

(76) Inventors: William C. KRESS, Vista, CA (US); Jonathan Yen, San Jose, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 12/194,025

(22) Filed: Aug. 19, 2008

(51) Int. Cl. G06K 9/40; G06K 9/00

(52) U.S. Cl. 382/167; 382/274

(57) ABSTRACT

The subject application is directed to backlit image adjustment. First, image data is received that includes an image portion defined by an associated backlit region, from which a tonal curve is then isolated. At least one anchor point on the isolated tonal curve is selected based upon backlighting characteristics in the received image data. A sectional bulging operation is applied on the isolated tonal curve in accordance with the selected anchor point. Adjusted image data is then generated based upon the applied sectional bulging operation, and is then communicated to an associated data storage

### BACKGROUND OF THE INVENTION

The subject application is directed generally to correction of backlit images. The application is particularly advantageous in connection with correction of images relative to backlighting characteristics particular to each acquired image.

Electronic images exist in many formats. By way of example, images may be acquired or stored in various schemes, including RAW, JPEG, GIF, TIFF or PCX, as well as many other image data types. Many image data encoding schemes define images in connection with a multidimensional color space, such as a space defined by either additive or subtractive primary colors. Such color spaces include red-green-blue (RGB); cyan, magenta, yellow (CYM), which is sometimes encoded with a blac(K) component as CMYK.

Acquired images, particularly those that result from real life images such as may be acquired by digital cameras or scans of photographs, are often captured in non-optimal situations. One such situation is presented with backlighting. A relatively bright backlighting tends to wash out or obscure objects in a forefront of such lighting. Backlighting is particularly problematic with human subjects insofar is it can result in obscured facial characteristics.

Earlier attempts at adjustment of images for backlighting artifacts included tonal remapping with piece-wise linear functions or with spatial masking. Such approaches, while somewhat effective, are frequently complex and computationally intensive, and nonetheless result in less than optimal adjustment to compensate for image backlighting.

### SUMMARY OF THE INVENTION

In accordance with one embodiment of the subject application, there is provided a system and method for correction of backlit images.

Further, in accordance with one embodiment of the subject application, there is provided a system and method for correction of images relative to backlighting characteristics particular to each acquired image.

Still further, in accordance with one embodiment of the subject application, there is provided a system and method for backlit image adjustment. Image data is received which includes an image portion defined by a backlit region associated therewith and a tonal curve is isolated. At least one anchor point on an isolated tonal curve is selected in accordance with backlighting characteristics in received image data and a sectional bulging operation is applied on the isolated tonal curve in accordance with the at least one anchor point. Adjusted image data is generated in accordance with an applied sectional bulging operation and communicated to an associated data storage.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The paten or application file contains at least one drawing executed in color. Copies of this patent or patent application publication with color drawing(s) will be provided by the Office upon request and payment of the necessary fee.

The subject application is described with reference to certain figures, including:

FIG. 1 is an overall diagram of a system for backlit image adjustment according to one embodiment of the subject application;

FIG. 2 is a block diagram illustrating controller hardware for backlit image adjustment according to one embodiment of the subject application;

FIG. 3 is a functional diagram illustrating the controller for use in the system for backlit image adjustment according to one embodiment of the subject application;

FIG. 4 is a diagram illustrating a workstation for use in the system for backlit image adjustment according to one embodiment of the subject application;

FIG. 5 illustrates an input image and adjusted image for use in the system for backlit image adjustment according to one embodiment of the subject application;

FIG. 6 is a sample tone reproduction curve associated with FIG. 5 for use in the system for backlit image adjustment according to one embodiment of the subject application;

FIG. 7 is a sample saturation boosting tone reproduction curve for use in the system for backlit image adjustment according to one embodiment of the subject application;

FIG. 8 is a sample tone reproduction curve and associated anchor point for use in the system for backlit image adjustment according to one embodiment of the subject application;

FIG. 9 is a sample tone reproduction curve and associated bulging operation for use in the system for backlit image adjustment according to one embodiment of the subject application;

FIG. 10 illustrates an input image and adjusted image for use in the system for backlit image adjustment according to one embodiment of the subject application;

FIG. 11 is a sample tone reproduction curve associated with FIG. 10 for use in the system for backlit image adjustment according to one embodiment of the subject application;

FIG. 12 illustrates an input image and adjusted image for use in the system for backlit image adjustment according to one embodiment of the subject application;

FIG. 13 is a sample tone reproduction curve associated with FIG. 12 for use in the system for backlit image adjustment according to one embodiment of the subject application;

FIG. 14 is a sample tone reproduction curve associated with FIG. 15 for use in the system for backlit image adjustment according to one embodiment of the subject application;

FIG. 15 illustrates a sample input image and associated adjusted image for use in the system for backlit image adjustment according to one embodiment of the subject application;

FIG. 16 is a sample input image and associated adjusted image for use in the system for backlit image adjustment according to one embodiment of the subject application;

FIG. 17 is a sample input image and associated adjusted image for use in the system for backlit image adjustment according to one embodiment of the subject application;

FIG. 18 is a sample input image and associated adjusted image for use in the system for backlit image adjustment according to one embodiment of the subject application;

FIG. 19 is a sample tone reproduction curve associated with FIG. 18 for use in the system for backlit image adjustment according to one embodiment of the subject application;

FIG. 20 is a flowchart illustrating a method for backlit image adjustment according to one embodiment of the subject application; and

FIG. 21 is a flowchart illustrating a method for backlit image adjustment according to one embodiment of the subject application.

### DETAILED DESCRIPTION OF THE PREFERRED EMBODIMENT

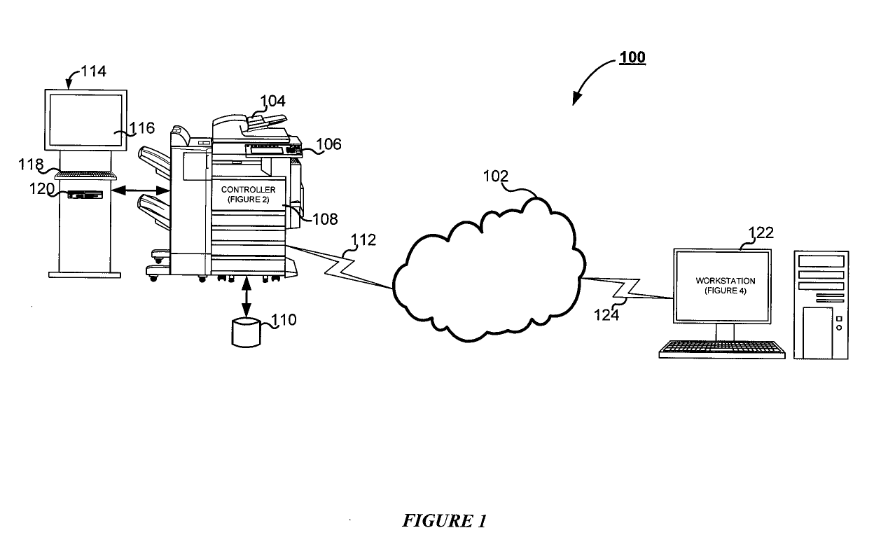

The subject application is directed to a system and method for correction of backlit images. In particular, the subject application is directed to a system and method for correction of images relative to backlighting characteristics particular to each acquired image. More particularly, the subject application is directed to a system and method for backlit image adjustment. It will become apparent to those skilled in the art that the system and method described herein are suitably adapted to a plurality of varying electronic fields employing image adjustment, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of a system 100 for backlit image adjustment in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

The system 100 also includes a document processing device 104, which is depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing device 104 is suitably adapted to provide remote document processing services to external or network devices. Preferably, the document processing device 104 includes hardware, software, and any suitable combination thereof, configured to interact with an associated user, a networked device, or the like.

According to one embodiment of the subject application, the document processing device 104 is suitably equipped to receive a plurality of portable storage media, including, without limitation, Firewire drive, USB drive, SD, MMC, XD, Compact Flash, Memory Stick, and the like. In the preferred embodiment of the subject application, the document processing device 104 further includes an associated user interface 106, such as a touch-screens LCD display, touch-panel, alpha-numeric keypad, or the like, via which an associated user is able to interact directly with the document processing device 104. In accordance with the preferred embodiment of the subject application, the user interface 106 is advantageously used to communicate information to the associated user and receive selections from the associated user. The skilled artisan will appreciate that the user interface 106 comprises various components, suitably adapted to present data to the associated user, as are known in the art. In accordance with one embodiment of the subject application, the user interface 106 comprises a display, suitably adapted to display one or more graphical elements, text data, images, or the like, to an associated user, receive input from the associated user, and communicate the same to a backend component, such as the controller 108, as explained in greater detail below. Preferably, the document processing device 104 is communicatively coupled to the computer network 102 via a communications link 112. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art.

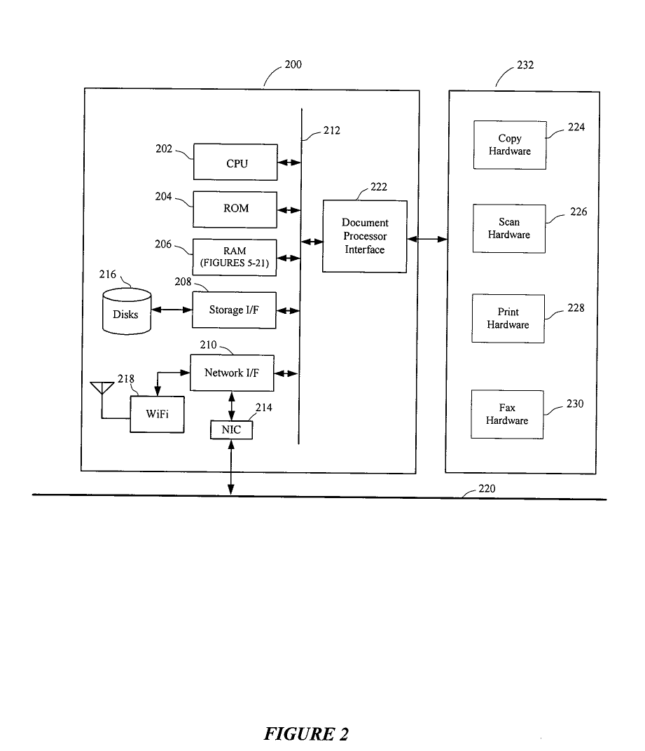

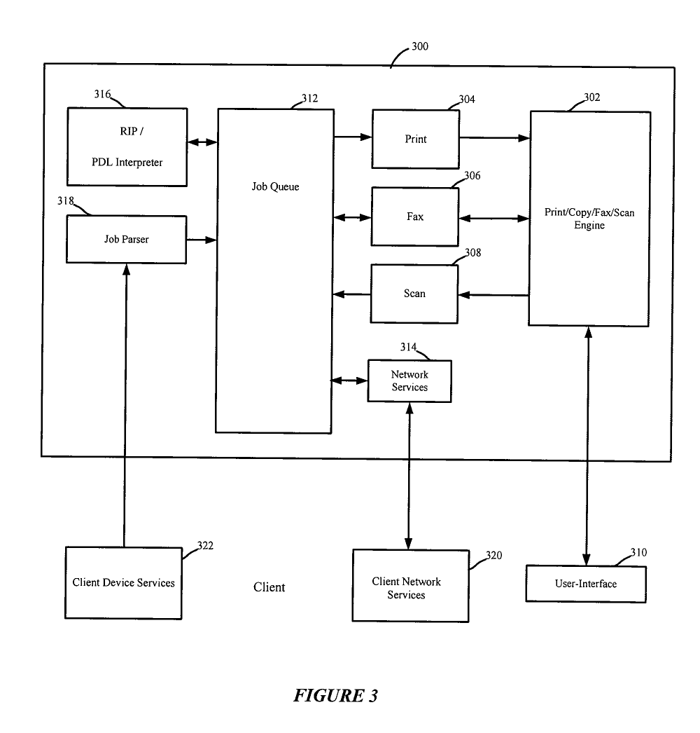

In accordance with one embodiment of the subject application, the document processing device 104 further incorporates a backend component, designated as the controller 108, suitably adapted to facilitate the operations of the document processing device 104, as will be understood by those skilled in the art. Preferably, the controller 108 is embodied as hardware, software, or any suitable combination thereof, configured to control the operations of the associated document processing device 104, facilitate the display of images via the user interface 106, direct the manipulation of electronic image data, and the like. For purposes of explanation, the controller 108 is used to refer to any myriad of components associated with the document processing device 104, including hardware, software, or combinations thereof, functioning to perform, cause to be performed, control, or otherwise direct the methodologies described hereinafter. It will be understood by those skilled in the art that the methodologies described with respect to the controller 108 is capable of being performed by any general purpose computing system, known in the art, and thus the controller 108 is representative of such general computing devices and are intended as such when used hereinafter. Furthermore, the use of the controller 108 hereinafter is for the example embodiment only, and other embodiments, which will be apparent to one skilled in the art, are capable of employing the system and method for backlit image adjustment of the subject application. The functioning of the controller 108 will better be understood in conjunction with the block diagrams illustrated in FIGS. 2 and 3, explained in greater detail below.

Communicatively coupled to the document processing device 104 is a data storage device 110. In accordance with the preferred embodiment of the subject application, the data storage device 110 is any mass storage device known in the art including, for example and without limitation, magnetic storage drives, a hard disk drive, optical storage devices, flash memory devices, or any suitable combination thereof. In the preferred embodiment, the data storage device 110 is suitably adapted to store document data, image data, electronic database data, or the like. It will be appreciated by those skilled in the art that while illustrated in FIG. 1 as being a separate component of the system 100, the data storage device 110 is capable of being implemented as an internal storage component of the document processing device 104, a component of the controller 108, or the like, such as, for example and without limitation, an internal hard disk drive, or the like. In accordance with one embodiment of the subject application, the data storage device 110 is capable of storing images, advertisements, user information, location information, output templates, mapping data, multimedia data files, fonts, and the like.

Illustrated in FIG. 1 is a kiosk 114, communicatively coupled to the document processing device 104, and in effect, the computer network 102. It will be appreciated by those skilled in the art that the kiosk 114 is capable of being implemented as separate component of the document processing device 104, or as integral components thereof. Use of the kiosk 114 in FIG. 1 is for example purposes only, and the skilled artisan will appreciate that the subject application is capable of implementation without the use of the kiosk 114. In accordance with one embodiment of the subject application, the kiosk 114 includes a display 116 and user input device 118. As will be understood by those skilled in the art the kiosk 114 is capable of implementing a combination user input device/display, such as a touch screen interface. According to one embodiment of the subject application, the kiosk 114 is suitably adapted to display prompts to an associated user, receive instructions from the associated user, receive payment data, receive selection data from the associated user, and the like. Preferably, the kiosk 114 includes a magnetic card reader, conventional bar code reader, or the like, suitably adapted to receive and read payment data from a credit card, coupon, debit card, or the like.

The system 100 of FIG. 1 also includes a portable storage device reader 120, coupled to the kiosk 114 and suitably adapted to receive and access a myriad of different portable storage devices. Examples of such portable storage devices include, for example and without limitation, flash-based memory such as SD, xD, Memory Stick, compact flash, CD-ROM, DVD-ROM, USB flash drives, or other magnetic or optical storage devices, as will be known in the art.

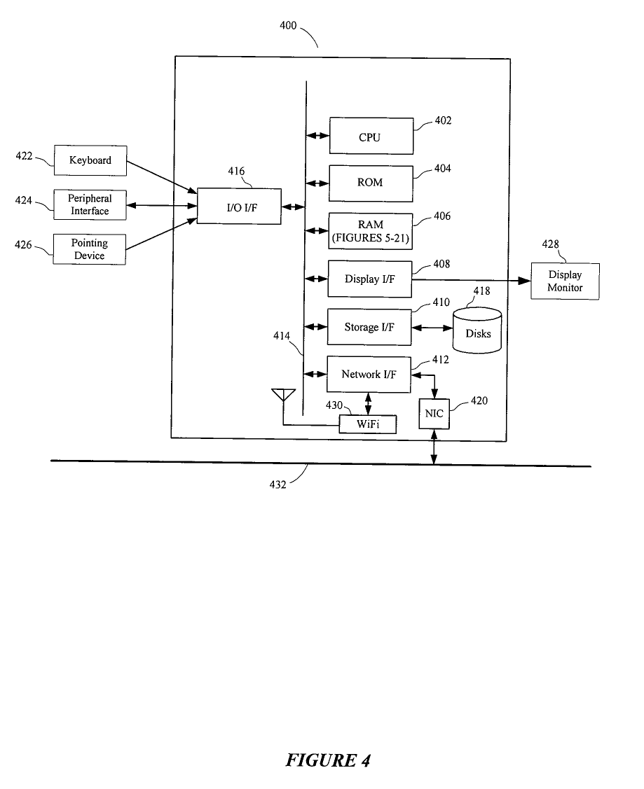

The system 100 illustrated in FIG. 1 further depicts a workstation 122, in data communication with the computer network 102 via a communications link 124. It will be appreciated by those skilled in the art that the workstation 122 is shown in FIG. 1 as a computer workstation for illustration purposes only. As will be understood by those skilled in the art, the workstation 122 is representative of any personal computing device known in the art, including, for example and without limitation, a laptop computer, a personal computer, a personal data assistant, a web-enabled cellular telephone, a smart phone, a proprietary network device, or other web-enabled electronic device. The communications link 124 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Preferably, the workstation 122 is suitably adapted to receive and modify image data, perform color calculations and conversions, generate display data, generate output data, or the like, to the document processing device 104, or any other similar device coupled to the computer network 102. The functioning of the workstation 122 will better be understood in conjunction with the block diagrams illustrated in FIG. 4, explained in greater detail below.

Turning now to FIG. 2, illustrated is a representative architecture of a suitable backend component, i.e., the controller 200, shown in FIG. 1 as the controller 108, on which operations of the subject system 100 are completed. The skilled artisan will understand that the controller 200 is representative of any general computing device, known in the art, capable of facilitating the methodologies described herein. Included is a processor 202, suitably comprised of a central processor unit. However, it will be appreciated that processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the controller 200.

Also included in the controller 200 is random access memory 206, suitably formed of dynamic random access memory, static random access memory, or any other suitable, addressable and writable memory system. Random access memory provides a storage area for data instructions associated with applications and data handling accomplished by processor 202.

A storage interface 208 suitably provides a mechanism for non-volatile, bulk or long term storage of data associated with the controller 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the controller 200 to communicate to other devices. The network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 214 is interconnected for data interchange via a physical network 220, suitably comprised of a local area network, wide area network, or a combination thereof.

Data communication between the processor 202, read only memory 204, random access memory 206, storage interface 208 and the network interface subsystem 210 is suitably accomplished via a bus data transfer mechanism, such as illustrated by the bus 212.

Also in data communication with the bus 212 is a document processor interface 222. The document processor interface 222 suitably provides connection with hardware 232 to perform one or more document processing operations. Such operations include copying accomplished via copy hardware 224, scanning accomplished via scan hardware 226, printing accomplished via print hardware 228, and facsimile communication accomplished via facsimile hardware 230. It is to be appreciated that the controller 200 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing device 104, which includes the controller 200 of FIG. 2, (shown in FIG. 1 as the controller 108) as an intelligent subsystem associated with a document processing device. In the illustration of FIG. 3, controller function 300 in the preferred embodiment, includes a document processing engine 302. A suitable controller functionality is that incorporated into the Toshiba e-Studio system in the preferred embodiment. FIG. 3 illustrates suitable functionality of the hardware of FIG. 2 in connection with software and operating system functionality as will be appreciated by one of ordinary skill in the art.

In the preferred embodiment, the engine 302 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that perform one or more of the document processing operations listed above.

The engine 302 is suitably interfaced to a user interface panel 310, which panel allows for a user or administrator to access functionality controlled by the engine 302. Access is suitably enabled via an interface local to the controller, or remotely via a remote thin or thick client.

The engine 302 is in data communication with the print function 304, facsimile function 306, and scan function 308. These functions facilitate the actual operation of printing, facsimile transmission and reception, and document scanning for use in securing document images for copying or generating electronic versions.

A job queue 312 is suitably in data communication with the print function 304, facsimile function 306, and scan function 308. It will be appreciated that various image forms, such as bit map, page description language or vector format, and the like, are suitably relayed from the scan function 308 for subsequent handling via the job queue 312.

The job queue 312 is also in data communication with network services 314. In a preferred embodiment, job control, status data, or electronic document data is exchanged between the job queue 312 and the network services 314. Thus, suitable interface is provided for network based access to the controller function 300 via client side network services 320, which is any suitable thin or thick client. In the preferred embodiment, the web services access is suitably accomplished via a hypertext transfer protocol, file transfer protocol, uniform data diagram protocol, or any other suitable exchange mechanism. The network services 314 also advantageously supplies data interchange with client side services 320 for communication via FTP, electronic mail, TELNET, or the like. Thus, the controller function 300 facilitates output or receipt of electronic document and user information via various network access mechanisms.

The job queue 312 is also advantageously placed in data communication with an image processor 316. The image processor 316 is suitably a raster image process, page description language interpreter or any suitable mechanism for interchange of an electronic document to a format better suited for interchange with device functions such as print 304, facsimile 306 or scan 308.

Finally, the job queue 312 is in data communication with a parser 318, which parser suitably functions to receive print job language files from an external device, such as client device services 322. The client device services 322 suitably include printing, facsimile transmission, or other suitable input of an electronic document for which handling by the controller function 300 is advantageous. The parser 318 functions to interpret a received electronic document file and relay it to the job queue 312 for handling in connection with the afore-described functionality and components.

Turning now to FIG. 4, illustrated is a hardware diagram of a suitable workstation 400, shown in FIG. 1 as the workstation 122, for use in connection with the subject system. A suitable workstation includes a processor unit 402 which is advantageously placed in data communication with read only memory 404, suitably non-volatile read only memory, volatile read only memory or a combination thereof, random access memory 406, display interface 408, storage interface 410, and network interface 412. In a preferred embodiment, interface to the foregoing modules is suitably accomplished via a bus 414.

The read only memory 404 suitably includes firmware, such as static data or fixed instructions, such as BIOS, system functions, configuration data, and other routines used for operation of the workstation 400 via CPU 402.

The random access memory 406 provides a storage area for data and instructions associated with applications and data handling accomplished by the processor 402.

The display interface 408 receives data or instructions from other components on the bus 414, which data is specific to generating a display to facilitate a user interface. The display interface 408 suitably provides output to a display terminal 428, suitably a video display device such as a monitor, LCD, plasma, or any other suitable visual output device as will be appreciated by one of ordinary skill in the art.

The storage interface 410 suitably provides a mechanism for non-volatile, bulk or long term storage of data or instructions in the workstation 400. The storage interface 410 suitably uses a storage mechanism, such as storage 418, suitably comprised of a disk, tape, CD, DVD, or other relatively higher capacity addressable or serial storage medium.

The network interface 412 suitably communicates to at least one other network interface, shown as network interface 420, such as a network interface card, and wireless network interface 430, such as a WiFi wireless network card. It will be appreciated by one of ordinary skill in the art that a suitable network interface is comprised of both physical and protocol layers and is suitably any wired system, such as Ethernet, token ring, or any other wide area or local area network communication system, or wireless system, such as WiFi, WiMax, or any other suitable wireless network system, as will be appreciated by one of ordinary skill in the art. In the illustration, the network interface 420 is interconnected for data interchange via a physical network 432, suitably comprised of a local area network, wide area network, or a combination thereof.

An input/output interface 416 in data communication with the bus 414 is suitably connected with an input device 422, such as a keyboard or the like. The input/output interface 416 also suitably provides data output to a peripheral interface 424, such as a USB, universal serial bus output, SCSI, Firewire (IEEE 1394) output, or any other interface as may be appropriate for a selected application. Finally, the input/output interface 416 is suitably in data communication with a pointing device interface 426 for connection with devices, such as a mouse, light pen, touch screen, or the like.

In operation, image data is first received that includes an image portion defined by an associated backlit region. A tonal curve associated with the received image data is then isolated. At least one anchor point on the isolated tonal curve is then selected based upon backlighting characteristics in the received image data. A sectional bulging operation is then applied on the isolated tonal curve in accordance with the selected anchor point. Adjusted image data is then generated in accordance with the applied sectional bulging operation. The adjusted image data is then communicated to an associated data storage.

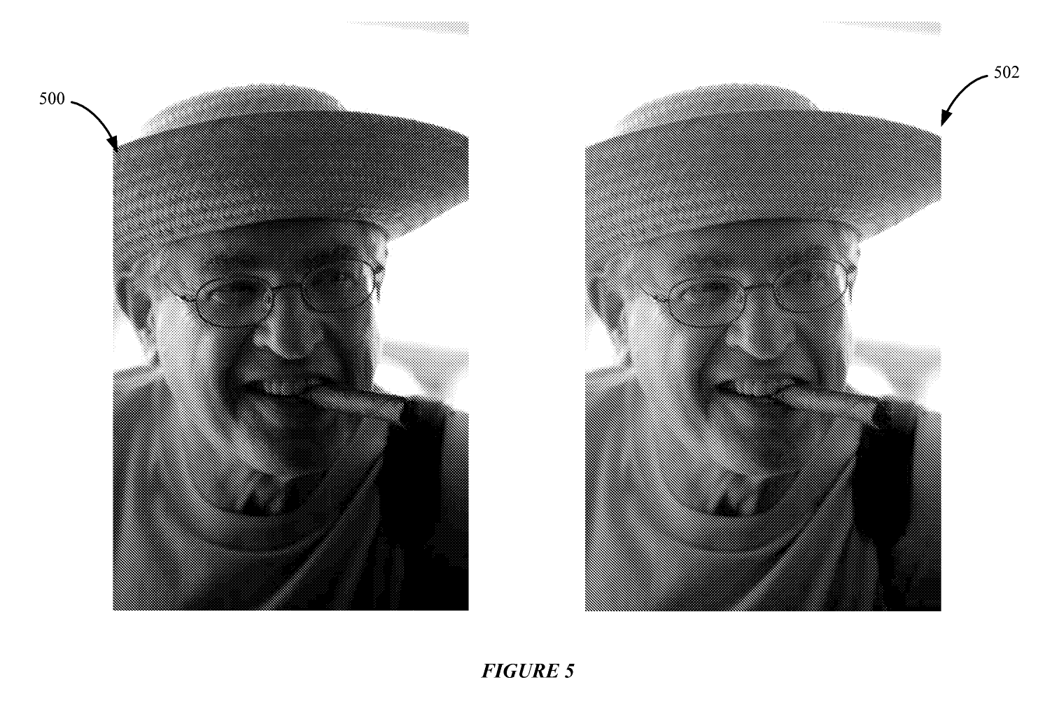

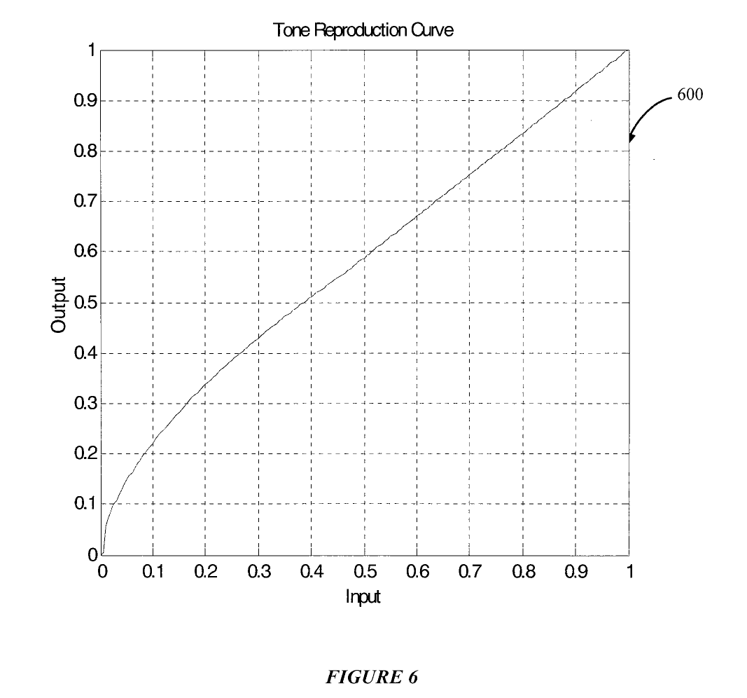

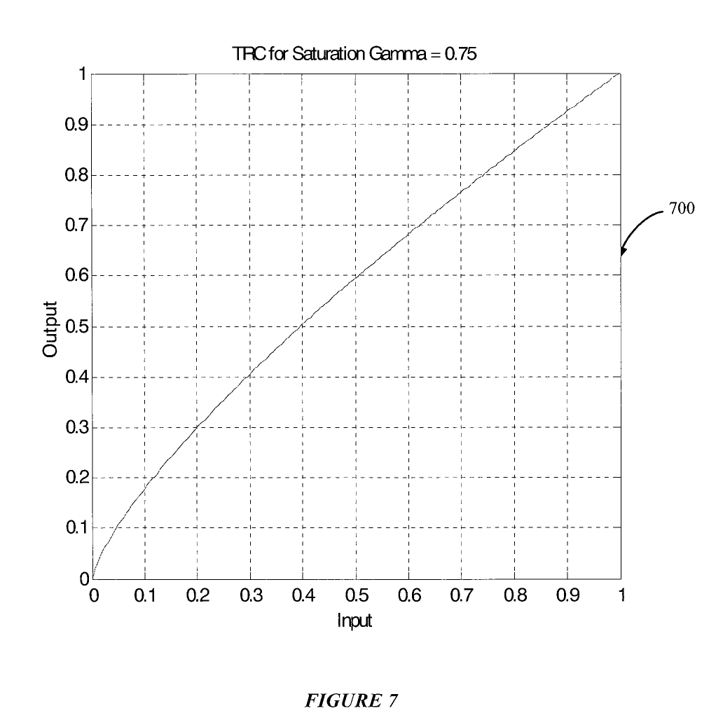

In accordance with one example embodiment of the subject application, image data is first received by the computer workstation 122, the document processing device 104, or other suitable processing device. It will be appreciated by those skilled in the art that the image data is capable of being received from operations of the document processing device 104, e.g. scanning, from an external device, e.g. camera, from a portable storage media, from a networked device (not shown), or the like. The workstation 122, controller 108 or other suitable component associated with the document processing device 104 then analyzes the received image data to determine whether the image includes a backlit portion. FIG. 5 shows an example of a backlit face 500 and the result of backlit face correction 502. A tonal curve associated with the received image data is then isolated by the computer workstation 122, the controller 108 or other suitable component associated with the document processing device 104, the kiosk 114, or other suitable processing device, as will be appreciated by those skilled in the art. FIG. 6 depicts a tone reproduction curve 600 for use in remapping the tone of an input image, e.g. the backlit face 500 of FIG. 5. FIG. 7 illustrates a tone reproduction curve 700 for boosting saturation of a given input image, e.g. image 500 of FIG. 5.

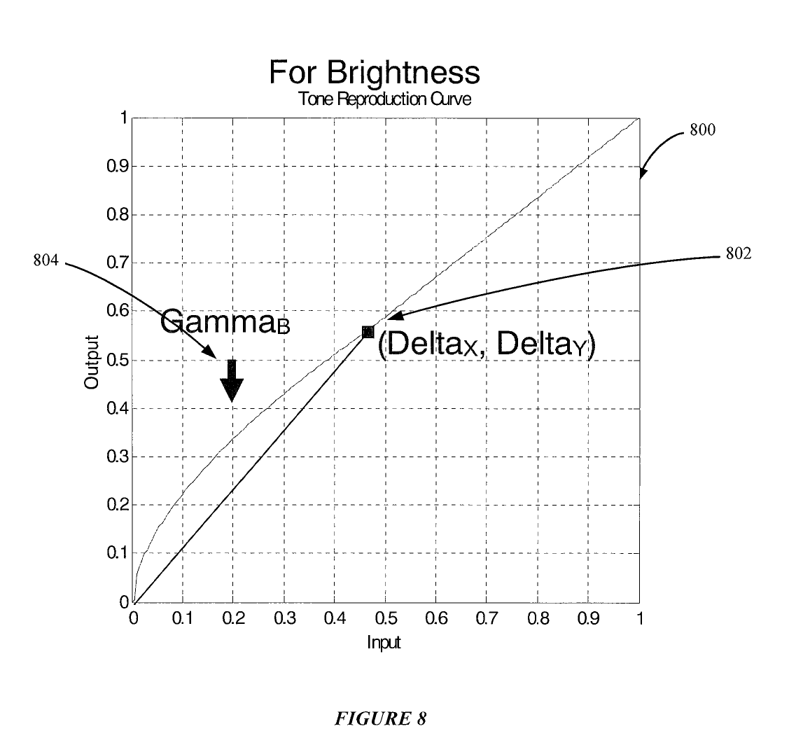

A first anchor point is then selected at a lower value on the tonal curve based upon backlighting characteristics in the received image data and a second anchor point is selected at a higher value on the tonal curve based upon the backlighting characteristics. FIG. 8 depicts a tone reproduction curve 800 for local brightening of an image, e.g. the image 500 of FIG. 5. A sectional bulging operation is then applied on the tonal curve at values between the selected first and second anchor points. As shown in FIG. 8, the curve 800 includes the selection of an anchor point 802 (Delta_{X}, Delta_{Y}) such that bulging with bulging factor gamma=Gamma_{B} 804 is applied to all levels below the anchor point while a linear mapping is applied to all levels above the anchor point 802. Adjusted image data is thereby generated by the workstation 122, the controller 108 or other suitable component associated with the document processing device 104.

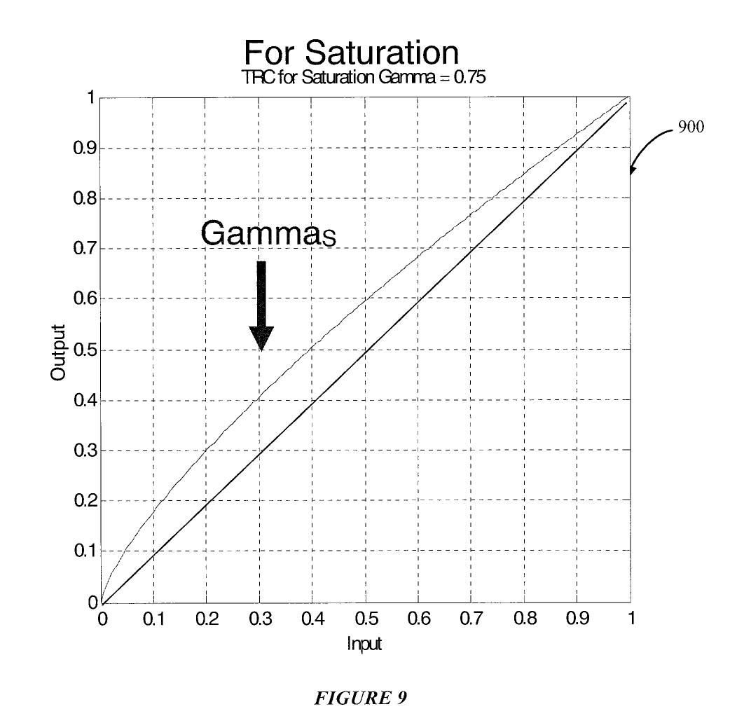

A saturation boost is then applied to the image via first converting the adjusted image data, e.g. the input image 500, from RGB color space to HSV color space. The workstation 122, the controller 108 or other suitable component associated with the document processing device 104 then extracts the S (saturation) plane. A boost bulging factor is then applied to the extracted S component. For example, a tone reproduction curve 900 with a bulging factor of Gamma_{S} 902 is then applied as shown in FIG. 9. The workstation 122, controller 108 or other suitable component associated with the document processing device 104 then combines the boosted S component with the remaining planes in HSV color space so as to generate a new image in HSV color space. The combined planes are then converted back from HSV color space to RGB color space, e.g. the corrected image 502 of FIG. 5. Thereafter, the workstation 122, the controller 108 or other suitable component associated with the document processing device 104 then communicates the adjusted image data to an associated data storage. In the case of the controller 108 performing the operations set forth above, the adjusted image data is stored in the data storage device 110 for further processing in accordance with user selected operations.

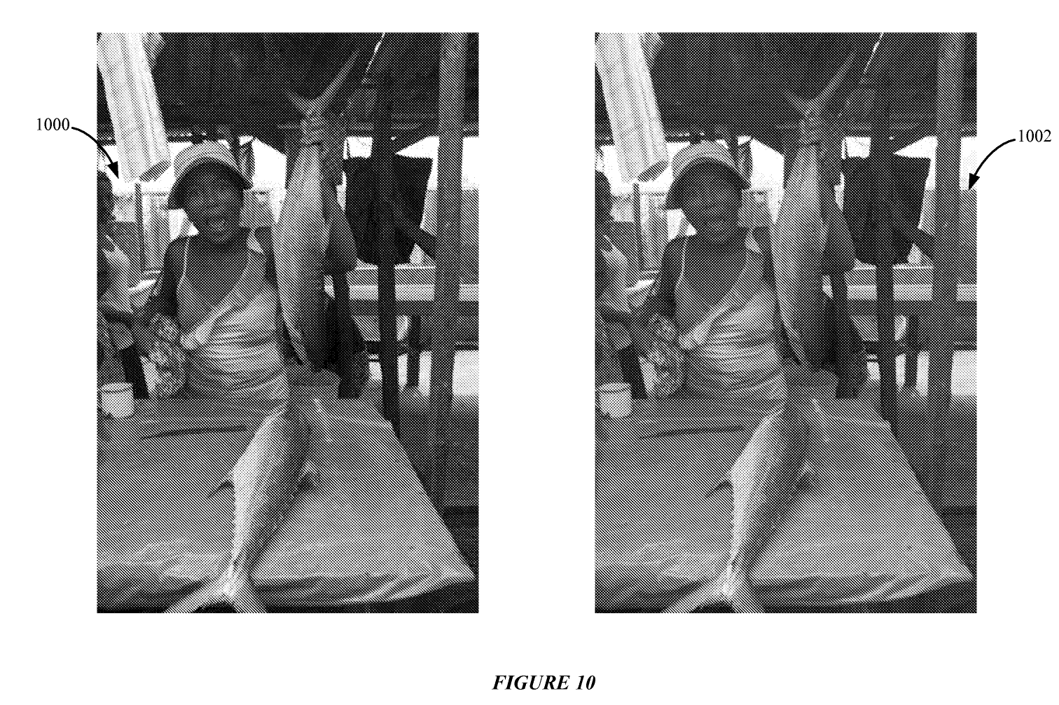

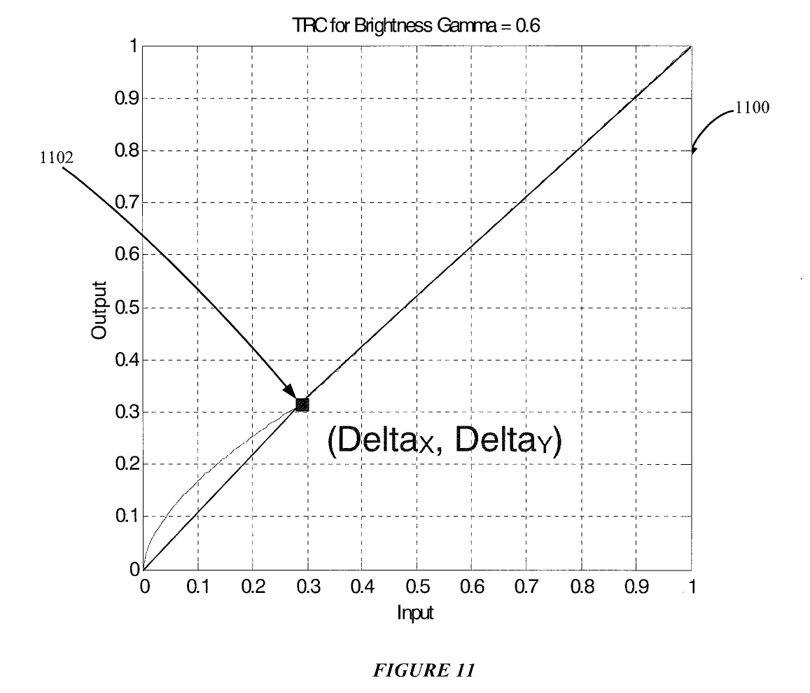

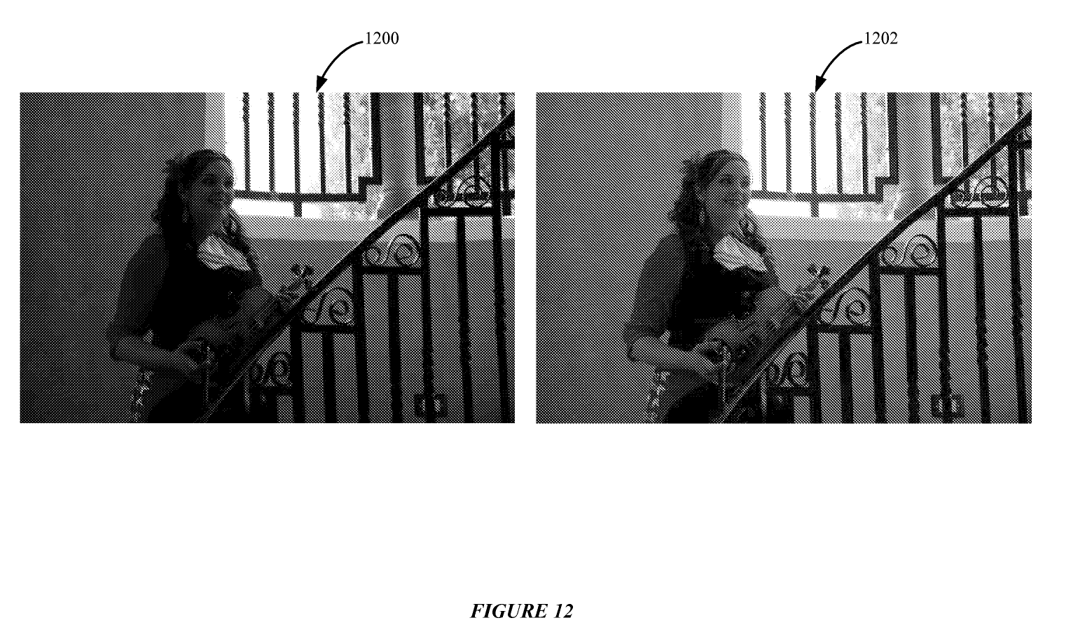

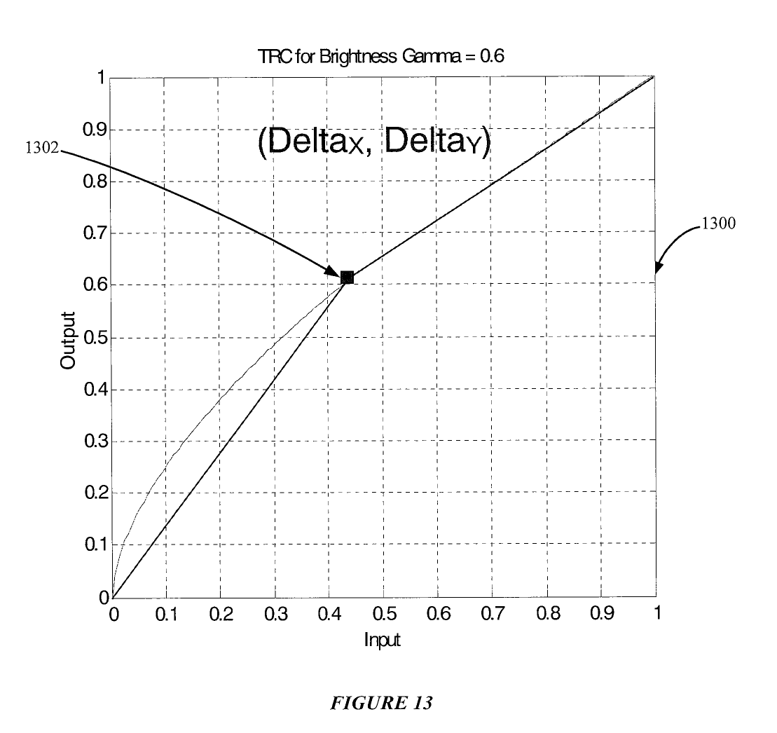

The skilled artisan will appreciate that various degrees of such tone remapping are capable of being applied through the selection of different anchor points and bulging factors. For example, FIG. 10 illustrates an example image 1000 having a lesser backlit face and a backlit corrected image 1002 generated in accordance with the subject application. FIG. 11 illustrates a tone reproduction curve 1100 having an anchor point 1102 selected at a lower point (value) on the curve. In contrast, FIG. 12 depicts an input image 1200 having a more backlit face and corresponding corrected image 1202 generated in accordance with the subject application. The tone reproduction curve 1300 of FIG. 13, corresponding to the image 1200 of FIG. 12, illustrates the selection of a higher anchor point 1302 in accordance with the subject application.

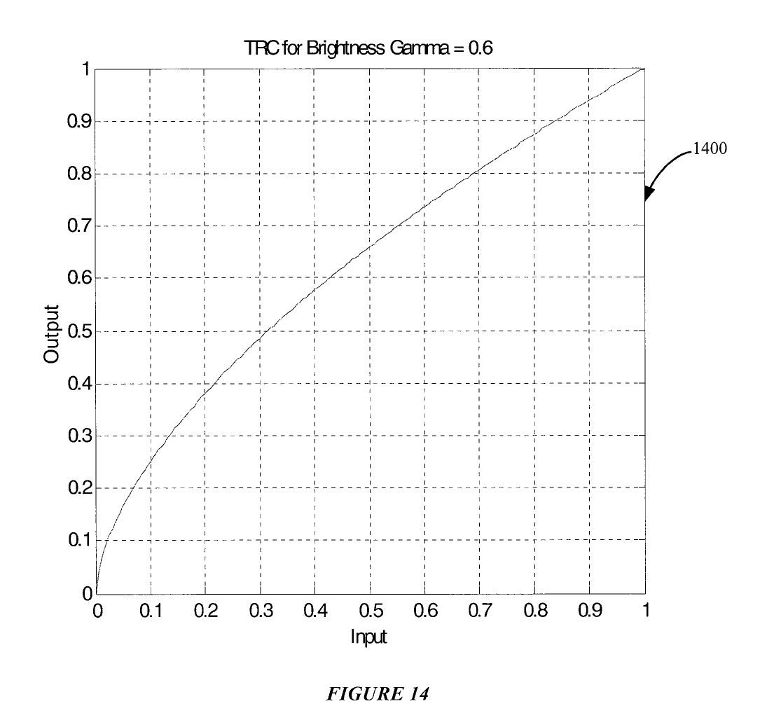

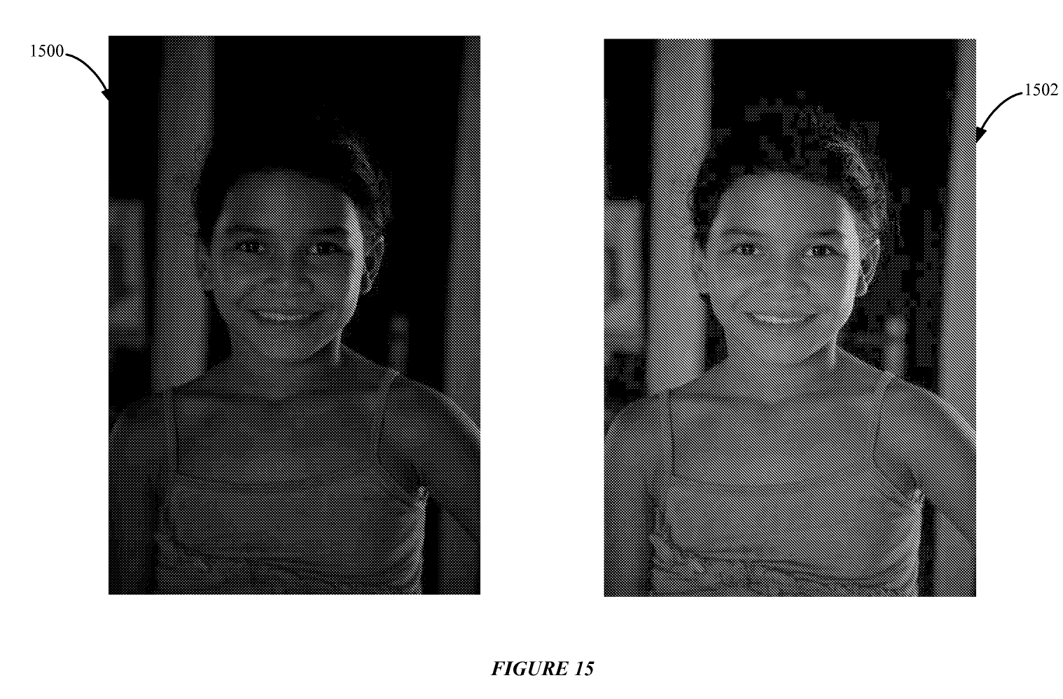

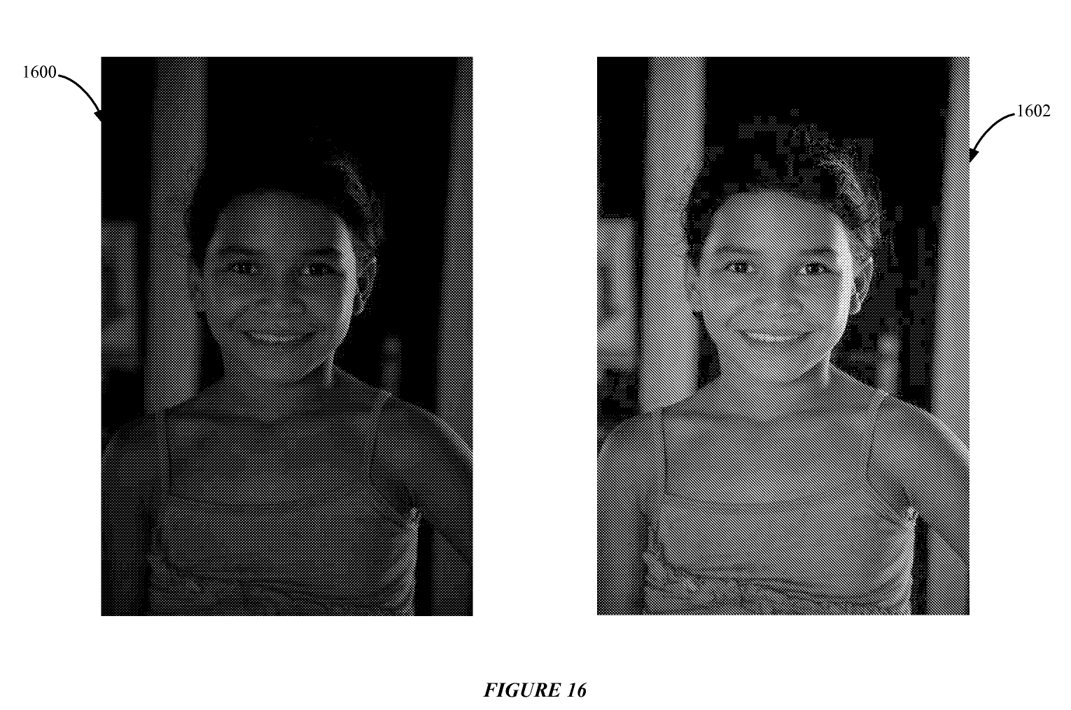

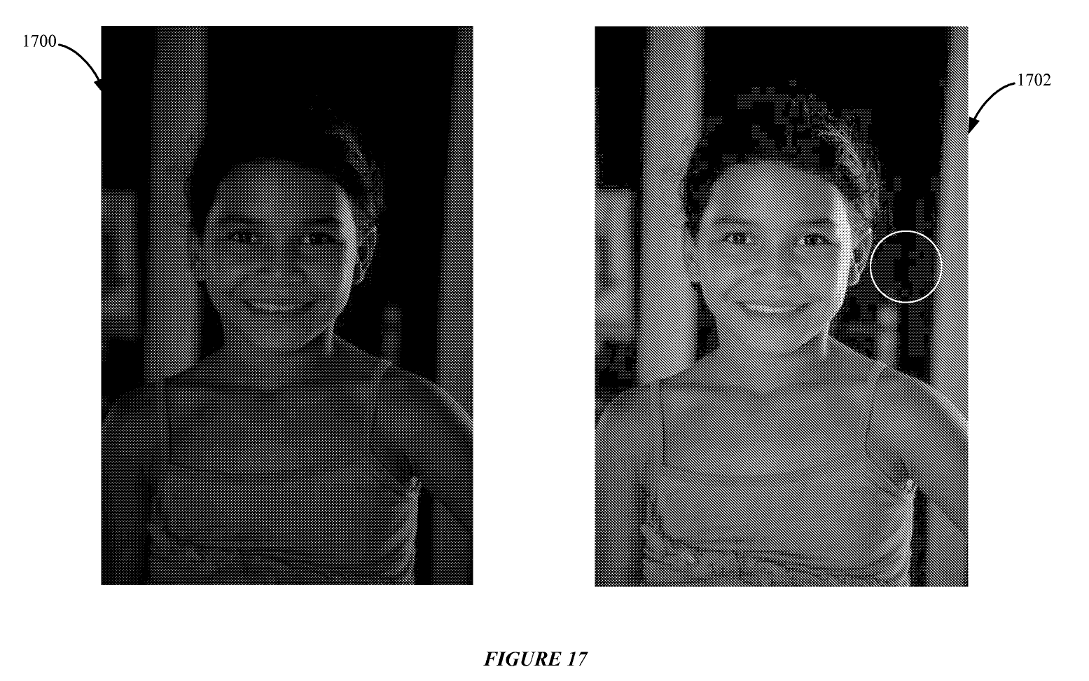

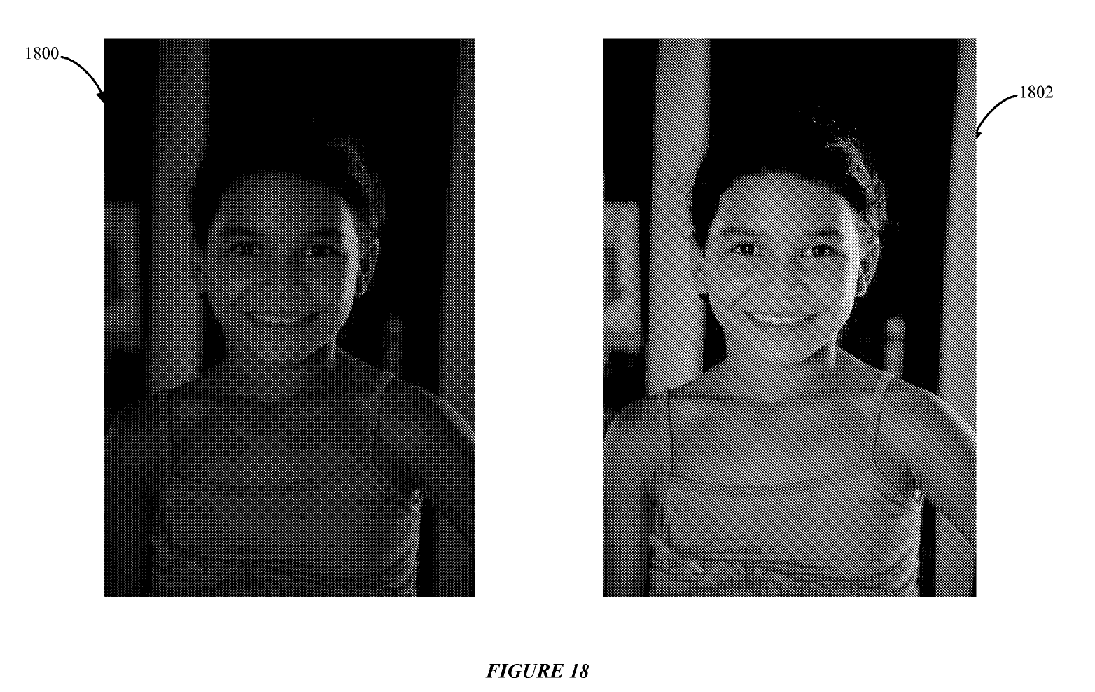

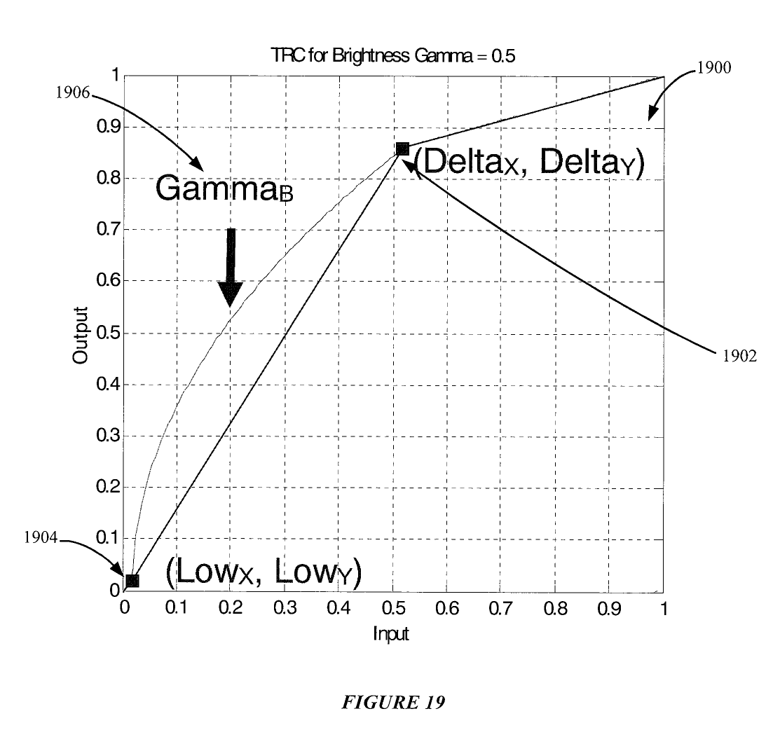

FIG. 14 illustrates a tone reduction curve 1400 applied to the image 1500 of FIG. 15 depicting the application of bulging over all levels for contrast enhancement. The skilled artisan will appreciate that in such an example, such bulging is suitably represented as a special (degenerated) case of sectional bulging wherein the anchor point is selected at (255, 255). FIG. 15 depicts a backlit image 1500 and corresponding adjusted image 1502, which illustrate contrast enhancement with bulging over all levels. FIG. 16 depicts the backlit image 1600 (1500 of FIG. 15) and a further contrast enhancement 1602 in accordance with the application of sectional bulging. FIG. 17 depicts the input image 1700 and corresponding adjusted image data 1702 in which application of the sectional bulging includes a second anchor point near the dark end to remove noise introduced by the process. FIG. 18 illustrates the resultant noise removal 1802 via means of sectional bulging with two anchor points. That is, FIG. 18 depicts the result of noise removal by a tone reduction curve 1900, as illustrated in FIG. 19, via means of sectional bulging with two anchor points 1902, 1904 such that the tone reduction curve 1900 begins by following the diagonal until the low anchor point (Low_{X}, Low_{Y}), bulging through the high anchor point (Delta_{X}, Delta_{Y}), and continues linearly to the end. The low anchor point 1904 of FIG. 19 corresponds to a point at (5, 5). The skilled artisan will appreciate that as shown in FIG. 19, a low anchor point at (5, 0) is equivalent of clipping, i.e. snapping all the low code values below 5 to 0.

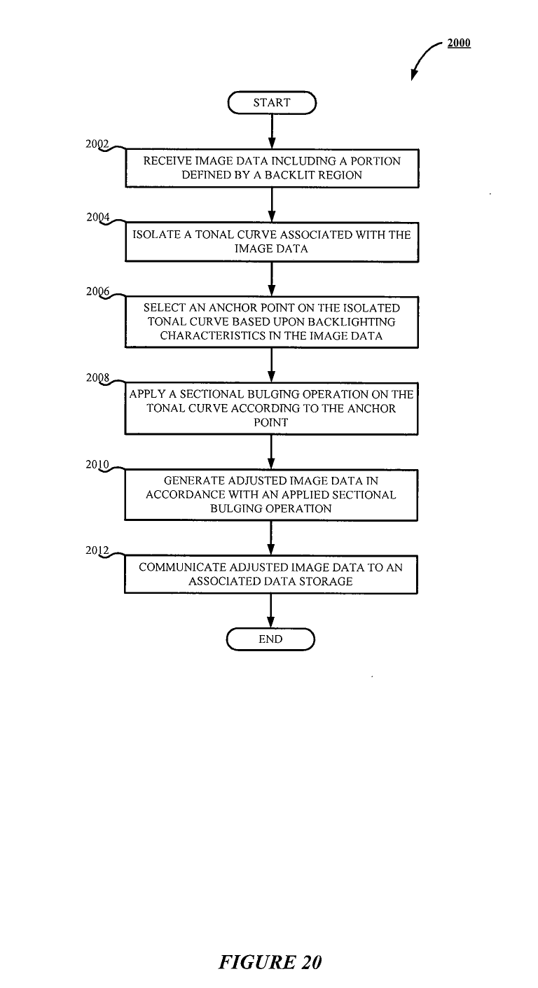

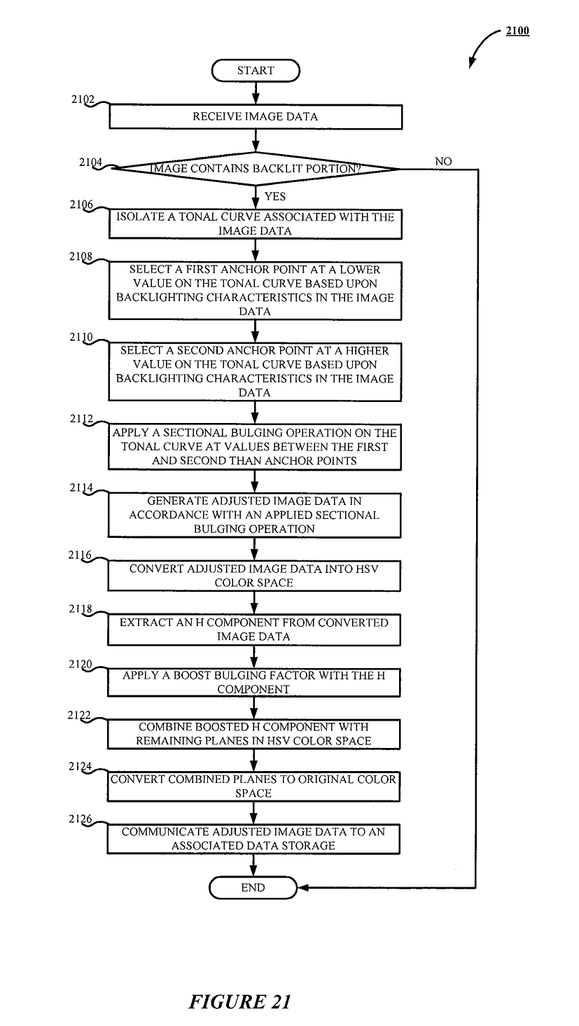

The skilled artisan will appreciate that the subject system 100 and components described above with respect to FIGS. 1-19 will be better understood in conjunction with the methodologies described hereinafter with respect to FIG. 20 and FIG. 21. Turning now to FIG. 20, there is shown a flowchart 2000 illustrating a method for backlit image adjustment in accordance with one embodiment of the subject application. For example purposes only, reference is made hereinafter to the computer workstation 122 performing the methodology of FIG. 20. The skilled artisan will appreciate that the kiosk 114, the controller 108 or other suitable component associated with the document processing device 104 are equally capable of implementing the method for backlit image adjustment as set forth in the subject application. Beginning at step 2002, image data is received by the workstation 122, the controller 108 or other suitable component associated with the document processing device 104, or other suitable computing device. In accordance with one embodiment of the subject application, the image data includes an image portion defined by a backlit region associated therewith. FIGS. 5, 10, 12, and 15-18 each suitably depict images having an associated backlit region, as discussed in greater detail above. It will be understood by those skilled in the art that while reference is made hereinafter to the computer workstation 122 performing the methodologies set forth in FIG. 20, any other suitable computing device is capable of being implemented in accordance with the subject application, e.g. the controller 108, kiosk 114, or the like. The skilled artisan will further appreciate that the image data is capable of being received by the workstation 122 from an operation of the document processing device 104, from an external device, e.g. a camera, scanner, or the like, from a local storage device, from a portable storage device, from a website, or other suitable sources of image data as are known in the art.

The workstation 122 then isolates a tonal curve associated with the received image data at step 2004. Suitable examples of such a tone reproduction curve for an input image are illustrated in FIGS. 6-9, 11, 13-14, and 19, discussed in greater detail above. At step 2006, the workstation 122 selects at least one anchor point on the isolated tonal curve based upon backlighting characteristics in the image data. For example, FIG. 11 illustrates a lower anchor point 1102 on the tonal curve 1100 corresponding to the image 1000 of FIG. 10. Additional examples of such anchor points are illustrated in FIGS. 8, 13, and 19, as discussed above. The workstation 122 then applies a sectional bulging operation on the isolated tonal curve in accordance with the at least one selected anchor point.

At step 2010, adjusted image data is generated in accordance with the applied sectional bulging operation by the computer workstation 122. The adjusted image data is then communicated by the workstation 122 to an associated data storage (not shown) at step 2012. In accordance with one embodiment of the subject application, the controller 108 or other suitable component associated with the document processing device 104 applies the sectional bulging operation so as to generate the adjusted image data at step 2010. The skilled artisan will thus appreciate that the adjusted image data is then communicated to the associated data storage 110 at step 2012.

Referring now to FIG. 21, there is shown a flowchart 2100 illustrating a method for backlit image adjustment in accordance with one embodiment of the subject application. For example purposes only, reference is made hereinafter to the computer workstation 122 implementing the methodology set forth in FIG. 15. The skilled artisan will appreciate that the kiosk 114, the controller 108 or other suitable component associated with the document processing device 104, or any other suitable computing device are equally capable of implementing the subject application. The method of FIG. 15 begins at step 1502, whereupon image data is received by the workstation 122.

The image data is then analyzed so as to determine, at step 2104, whether the received image data contains a backlit portion. When the workstation 122 determines that the received image data does not include a backlit portion, operations with respect to FIG. 21 terminate. The skilled artisan will appreciate that the determination on the presence of a backlit portion of the image data is made in accordance with the backlight characteristics of the image data including, for example and without limitation, the primary subject is darker than its surroundings. Upon a determination at step 2104 that the received image data includes a backlit portion, flow proceeds to step 2106.

At step 2106, the computer workstation 122 isolates a tonal curve associated with the image data, as will be appreciated by those skilled in the art. Suitable examples of such tone reproduction curves are illustrated above with respect to FIGS. 5-19. At step 2108, a first anchor is selected at a lower value on the tonal curve based upon backlighting characteristics in the image data. A second anchor is then selected at a higher value on the tonal curve based upon backlighting characteristics at step 2110.

The workstation 122 then applies a sectional bulging operation on the tonal curve at values between the first and second selected anchor points at step 2112. Adjusted image data is then generated by the workstation 122 at step 2114 in accordance with the applied sectional bulging operation. The workstation 122 then converts the adjusted image data from RGB color space to HSV color space at step 2116. An S component of the converted image data is extracted by the workstation 122 at step 2118. The workstation 122 then applies a boost bulging factor to the S component at step 2120. At step 2122, the boosted S component is combined with the remaining planes in HSV color space by the workstation 122. The combined planes in HSV color space are then converted to RGB color space at step 2124. Thereafter, at step 2126, the adjusted image data is communicated to an associated data storage by the workstation 122, e.g. an internal hard disk drive, system memory, portable storage media, optical recording media, or the like. It will be appreciated by those skilled in the art that steps 2116-2124 correspond to the application of a saturation boost to the adjusted image data prior to the communication thereof to the associated data storage.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A backlit image adjustment system comprising:
means adapted for receiving image data, which image data includes an image portion defined by a backlit region associated therewith;
means adapted for isolating a tonal curve associated with received image data;
means adapted for selecting at least one anchor point on an isolated tonal curve in accordance with backlighting characteristics in received image data;
means adapted for applying a sectional bulging operation on the isolated tonal curve in accordance with the at least one anchor point;
means adapted for generating adjusted image data in accordance with an applied sectional bulging operation; and
means adapted for communicating adjusted image data to an associated data storage.

2. The system of claim 1 further comprising saturation boost means adapted for application of a saturation boost to the adjusted image data prior to communication thereof to the associated data storage.

3. The system of claim 1 wherein the sectional bulging operation is performed on the isolated tonal curve at values lower than that defined by an anchor point.

4. The system of claim 1 wherein the at least one anchor point is positioned on the isolated tonal curve at a lower value when the received image data includes lesser backlit characteristics and positioned at a higher value when the received image data includes higher backlit characteristics.

5. The system of claim 1 wherein the means adapted for selecting at least one anchor point, includes selecting at least first and second anchor points, wherein the first anchor point is selected at a lower value on the isolated tonal curve and wherein the second anchor point is selected at a higher value on the isolated tonal curve, and wherein the sectional bulging operation is performed on the tonal curve between the first and second anchor points.

6. The system of claim 4 further comprising saturation boost means adapted for application of a saturation boost to the adjusted image data prior to communication thereof to the associated data storage.

7. The system of claim 6 wherein the saturation boost means includes:
conversion means adapted for converting adjusted image data from an original color space into HSV space;
extracting means adapted for extracting an S component from the converted image data;
means adapted for applying a boost bulging factor with the extracted S component;
means adapted for combining a boosted S component with remaining planes in HSV space; and
means adapted for converting combined planes to the original color space.

8. A backlit image adjustment method comprising the steps of:
receiving image data, which image data includes an image portion defined by a backlit region associated therewith;
isolating a tonal curve associated with received image data;
selecting at least one anchor point on an isolated tonal curve in accordance with backlighting characteristics in received image data;
applying a sectional bulging operation on the isolated tonal curve in accordance with the at least one anchor point;
generating adjusted image data in accordance with an applied sectional bulging operation; and
communicating adjusted image data to an associated data storage.

9. The method of claim 8 further comprising the step of applying a saturation boost to the adjusted image data prior to communication thereof to the associated data storage.

10. The method of claim 8 wherein the sectional bulging operation is performed on the isolated tonal curve at values lower than that defined by an anchor point.

11. The method of claim 8 wherein the at least one anchor point is positioned on the isolated tonal curve at a lower value when the received image data includes lesser backlit characteristics and positioned at a higher value when the received image data includes higher backlit characteristics.

12. The method of claim 8 wherein the step of selecting at least one anchor point, includes selecting at least first and second anchor points, wherein the first anchor point is selected at a lower value on the isolated tonal curve and wherein the second anchor point is selected at a higher value on the isolated tonal curve, and wherein the sectional bulging operation is performed on the tonal curve between the first and second anchor points.

13. The method of claim 12 further comprising the step of applying a saturation boost to the adjusted image data prior to communication thereof to the associated data storage.

14. The method of claim 13 wherein the step of applying a saturation boost includes:
converting adjusted image data from an original color space into HSV space;
extracting an S component from the converted image data;
applying a boost bulging factor with the extracted S component;
combining a boosted S component with remaining planes in HSV space; and
converting combined planes to the original color space.
